(19) United States
(12) Patent Application Publication
(10) Pub. No.: US 2005/0013897 A1
(43) Pub. Date: Jan. 20, 2005

(54) Long-lasting crustacean bait for use in traps and method of making the same

(76) Inventors: John M. Meyer JR., Green Bay, WI (US); Stephanie A. Dutkowski, Green Bay, WI (US); Robert A. Garrity, De Pere, WI (US); Ricky J. Teune, De Pere, WI (US)

Correspondence Address: REINHART BOERNER VAN DEUREN S.C.;ATTN: LINDA GABRIEL, DOCKET COORDINATOR, 1000 NORTH WATER STREET, SUITE 2100, MILWAUKEE, WI, 53202, US

(21) Appl. No.: 10/619,044

(22) Filed: Jul. 14, 2003

(51) Int. Cl. A23L 1/00

(52) U.S. Cl. 426/1

(57) ABSTRACT

An improved bait for use in attracting crustaceans in traps and pots is disclosed which is particularly long-lasting when used in such traps and pots in any of a wide variety of underwater environments, together with a preferred method for making the crustacean bait. The improved crustacean bait is made of hides such as cowhides which are processed to remove the hair therefrom, and then is cured and cut into pieces of an appropriate size for use as crustacean bait in traps or pots. The pieces of improved crustacean bait may be packaged in sealed bulk packages which do not require refrigeration. The improved crustacean bait is very long-lasting when placed into a trap or pot in the ocean, and will neither decompose over an extended period of time nor degrade in its attractiveness to lure crustaceans over an extended period of time.

### BACKGROUND OF THE INVENTION

### FIELD OF THE INVENTION

The present invention relates generally to bait for use in attracting crustaceans in traps and pots, and more particularly to an improved, long-lasting crustacean bait and a method for making the crustacean bait.

In recent years, the popularity of crustaceans such as lobster and crabs has increased substantially. Most of these crustaceans are caught by commercial fishermen who set traps or pots on the ocean bottom in areas where there is a substantial population of the desired crustaceans. These traps or pots have an entrance which is easy for a crustacean to crawl through to enter the trap, but difficult to impossible for the crustacean to use to leave the trap or pot once the crustacean has fully entered the trap or pot. Such traps or pots are mostly made of steel wire, although in years gone by they were made in part of wooden construction.

The traps or pots are baited with a crustacean bait which will attract the crustacean to the trap or pot. The crustacean bait is located within the trap or pot, and is typically fastened in place by impaling it upon a pin, hook, wire, or similar bait retaining mechanism. Once the trap or pot is baited, it is lowered onto the ocean floor, where it will remain for an extended interval of days to as much as a week or more. The traps or pots have a buoy connected to them, with the buoy both indicating the location of the trap or pot and allowing the fisherman to easily retrieve the trap or pot from the ocean floor.

The material used as bait for crustaceans varies somewhat by geographic location, although it generally consists of scraps or other low cost materials. In the Northeast U.S. and Eastern Canada, fish parts are the most common bait material used as bait for crustaceans. In the Northwest U.S. and Western Canada, razor clams and squid are used in addition to the use of fish parts as bait for crustaceans. In the Southeast U.S., waste chicken pieces are used in addition to fish parts as bait for crustaceans.

In Florida, pig's feet and raw cowhide are used in addition to fish parts as bait for crustaceans. While both of these are longer-lasting than fish or chicken parts, they present other problems. Raw cowhide has hair on it, and the hair can become detached as the raw cowhide disintegrates, potentially resulting in an entire shipment of lobsters being rejected if even a single lobster is contaminated with hair. The raw cowhide is also generally in large pieces which must be cut up, and the raw cowhide is decomposing and has an extremely foul smell. Pig's feet leave bones in the traps which are viewed as a substantial disadvantage, and the pigs feet may contain free hair as well. Pigs feet must also be frozen, or they will decompose and have a foul smell as well. It will be appreciated by those skilled in the art that a fresh supply of such baits must be procured on a daily basis. In addition, the availability of such baits is apt to be inconsistent.

While all of these materials which are used as crustacean bait are effective in attracting lobster and crabs, they all have a substantial disadvantage in that they are not sufficiently long-lasting in the environment of the ocean. What occurs to the bait materials is that they rapidly degrade in their quality as bait and also gradually disintegrate and/or are eaten by seals, sand fleas, and ocean perch. The disintegration of the bait is affected by the temperature of the ocean waters. For example, in geographic areas with warmer ocean waters, fish bait lasts only one day or so. In cooler ocean waters, it will still last only two or three days at best—far too short a time interval given the longer times between retrieval of the crustacean traps or pots.

As might be expected, there have been a number of different approaches which are found in the art. Several of these approaches deal with the use of material derived from animals. For example, U.S. Pat. No. 2,054,565, to Stovall et al., discloses the use of pork rind cured in glycerin as a bait material for fishing. U.S. Pat. No. 2,826,853, to Guy et al., and U.S. Pat. No. 3,964,203, to Williams, Jr. disclose the use of chamois strips on fishing hooks as lures. U.S. Pat. No. 5,524,377, to Freeman et al., teaches the use of a lure having an artificial chamois tail portion. U.S. Pat. No. 5,007,194, to Coody, discloses the use of a lure made of a segment of sheepskin mounted on a fishhook. However, none of these baits are suitable for use as a crustacean bait.

Several baits have been proposed for use specifically with crustaceans. U.S. Pat. No. 4,206,236, to Orth, Jr., teaches the use of an animal food material which is comminuted (pulverized) into a tiny particle size and blended with a polyol preservative and an attapulgus clay to produce a putty-like material which is extruded into shaped bait segments. U.S. Pat. No. 5,281,425, to Stribling et al., uses unrendered skeletal remains of poultry, pork, or beef which are ground to a hamburger-like consistence and then packed in casings to produce bait “sausages.” U.S. Pat. No. 6,419,964, to Rickards, uses poultry waste which is processed to remove feathers and internal organs, packaged, and sterilized. None of these products are long-term stable in the wide variety of ocean environments.

Still another approach is found in U.S. Pat. No. 3,864,498, to Whitmore et al., which prepares a shrimp and fish food from cowhides. The cowhides have the hair removed from them, are comminuted to a small particle size, and are heated with water to a high temperature and homogenized. The resulting admixture is mixed with dry meal and extruded to form feed pellets. Two references which disclose how to remove the hair from the cowhides are U.S. Pat. No. 3,751, 221, to Elvrum, and U.S. Pat. No. 4,484,924, to Pfleiderer et al., which both use an alkali solution to remove the hair from the cowhides and a salt bath to cure the cowhides. A myriad of other references are all related to producing fish, shrimp, or crustacean feed for use in commercial farming operations, but none of these references teach the manufacture of a bait material which is suitable for use in crustacean traps and pots.

It is accordingly the primary objective of the present invention that it provide an improved crustacean bait which will be long-lasting when placed into a trap or pot in the ocean. It is a related objective of the present invention that the improved crustacean bait not decompose over an extended period of time or degrade in its attractiveness to lure crustaceans into a trap or pot into which the improved crustacean bait has been placed. It is another related objective of the present invention that the improved crustacean bait also have a very long shelf life, both before and after the packaging in which the improved crustacean bait is supplied is opened.

It is another objective of the present invention that the improved crustacean bait be precut to pieces of the proper size for use in crustacean traps and pots, thereby obviating both the need to cut it to pieces of the proper size and the concurrent potential for injuries incurred while cutting bait. It is a further objective of the present invention that the improved crustacean bait have little or no odor, and that it not be particularly attractive to flies. It is yet another objective of the present invention that the improved crustacean bait be environmentally friendly and that it present no health or safety drawbacks in its use as a bait for crustaceans.

It is a still further objective of the present invention that the improved crustacean bait be storable at room temperature rather than needing to be frozen, thereby obviating the need to store it in a refrigerator or in a freezer. In addition to all of its other advantages, the improved crustacean bait must be convenient to obtain, to store, and to use. In order to enhance the market appeal of the improved crustacean bait of the present invention, it should also be relatively inexpensive to purchase to thereby afford it the broadest possible market. Finally, it is also an objective that all of the aforesaid advantages and objectives be achieved without incurring any substantial relative disadvantage.

### SUMMARY OF THE INVENTION

The disadvantages and limitations of the background art discussed above are overcome by the present invention. With this invention, an improved crustacean bait is made of hides such as cowhides which are processed to remove the hair therefrom, and then is cured and cut into pieces of an appropriate size for use as crustacean bait in traps or pots. The improved crustacean bait of the present invention may be packaged in sealed bulk packages which do not require refrigeration. The improved crustacean bait of the present invention is long-lasting, and will neither decompose over an extended period of time nor degrade in its attractiveness to lure crustaceans over an extended period of time in use as bait in a trap or pot even in warmer ocean waters.

The process which is used to make the improved crustacean bait of the present invention has three principal processes which are performed: a hair removal process, a neutralization process, and a curing process. Prior to beginning the hair removal process, the hides may first be rinsed to remove foreign materials, manure, and dirt. Optionally, a detergent can be used when rinsing the cowhides if they are extremely soiled and dirty. During rinsing, as in all of the succeeding processes, the hides are placed in a mixing device which serves to agitate the hides and liquids to facilitate the process. Once rinsed, the water is drained from the mixing device prior to the hides having the hair removed from them.

The hair removal process uses an alkali material mixed with water as the agent to remove the hair from the hides. During the hair removal process, the hides and the alkali-water solution are agitated in the mixing device to facilitate the hair removal process. The hair removal process typically can take several hours to remove all of the hair from the hides. Following the hair removal process, the alkali-water mixture is drained and the hides are rinsed to remove the hair from the mixing device. The rinse water is drained from the mixing device prior to beginning the neutralization process.

The neutralization process uses an acid material mixed with water to neutralize the hides. During the neutralization process, the hides and the acid-water solution are agitated in the mixing device. The pH of the solution is checked during the neutralization process, and if the pH is too high, additional acid material is added to the mixing device. When the pH of the acid-water solution is acceptable, the acid-water mixture is drained from the mixing device prior to beginning the curing process.

The curing process uses salt to cure the hides, and after salt is added to the mixing device, the hides and salt are agitated for a number of hours. No water is added to the mixing device for the curing process; however, there is residual water contained therein prior to the addition of the salt, and the salt displaces water in the hides. Thus, there is a brine solution in the mixing device together with the hides during the curing process. Optionally, a brightening agent can also be added during the curing process to whiten the hides, which will make them more visible in traps or pots on the ocean floor. Following completion of the curing process, the hides and the brine solution are removed from the mixing device.

Next, the hides are cut into pieces of the desired size, typically approximately four inches square. Optionally, each piece may be perforated by punching a hole in a location proximate the center of each piece. The improved crustacean bait of the present invention is then ready for packaging, and it is typically packaged in bulk plastic bags which are hermetically heat sealed. Optionally, prior to sealing the bags a flavoring additive may be added, such as fish oil from any of a variety of different fish including mackerel, tuna, anchovy, herring, menhaden, etc. to produce a variety of different flavors. The plastic bags are then heat sealed and ready for shipment to distributors and end users of the improved crustacean bait of the present invention.

It may therefore be seen that the present invention teaches an improved crustacean bait which is very long-lasting when placed into a trap or pot in the ocean. The improved crustacean bait of the present invention will neither decompose over an extended period of time nor degrade in its attractiveness to lure crustaceans into a trap or pot into which the improved crustacean bait has been placed. The improved crustacean bait of the present invention also has a very long shelf life, both before and after the packaging in which the improved crustacean bait is supplied is opened.

The improved crustacean bait of the present invention is precut to pieces of the proper size for use in crustacean traps and pots, thereby obviating both the need to cut it to pieces of the proper size and the concurrent potential for injuries incurred while cutting bait. The improved crustacean bait of the present invention has little or no odor, and it is not particularly attractive to flies. In addition, the improved crustacean bait of the present invention is environmentally friendly and thus presents no health or safety drawbacks in its use as a bait for crustaceans.

The improved crustacean bait of the present invention is cured and may be stored at room temperature rather than being frozen, thereby obviating the need to store it in a refrigerator or in a freezer. In addition to all of its other advantages, the improved crustacean bait of the present invention is convenient to obtain, to store, and to use. The improved crustacean bait of the present invention is also relatively inexpensive to purchase to enhance its market appeal and to thereby afford it the broadest possible market. Finally, all of the aforesaid advantages and objectives of the improved crustacean bait of the present invention are achieved without incurring any substantial relative disadvantage.

### DESCRIPTION OF THE DRAWINGS

These and other advantages of the present invention are best understood with reference to the drawings, in which:

FIG. 1 is a flowchart illustrating the preferred process of the present invention which is used to make the improved crustacean bait of the present invention;

FIG. 2 is a partially cutaway view from the side of a mixer for use in making the improved crustacean bait of the present invention; and

FIG. 3 is a plan view showing several pieces of the improved crustacean bait which have been made according to the teachings of the present invention.

### DETAILED DESCRIPTION OF THE PREFERRED EMBODIMENT

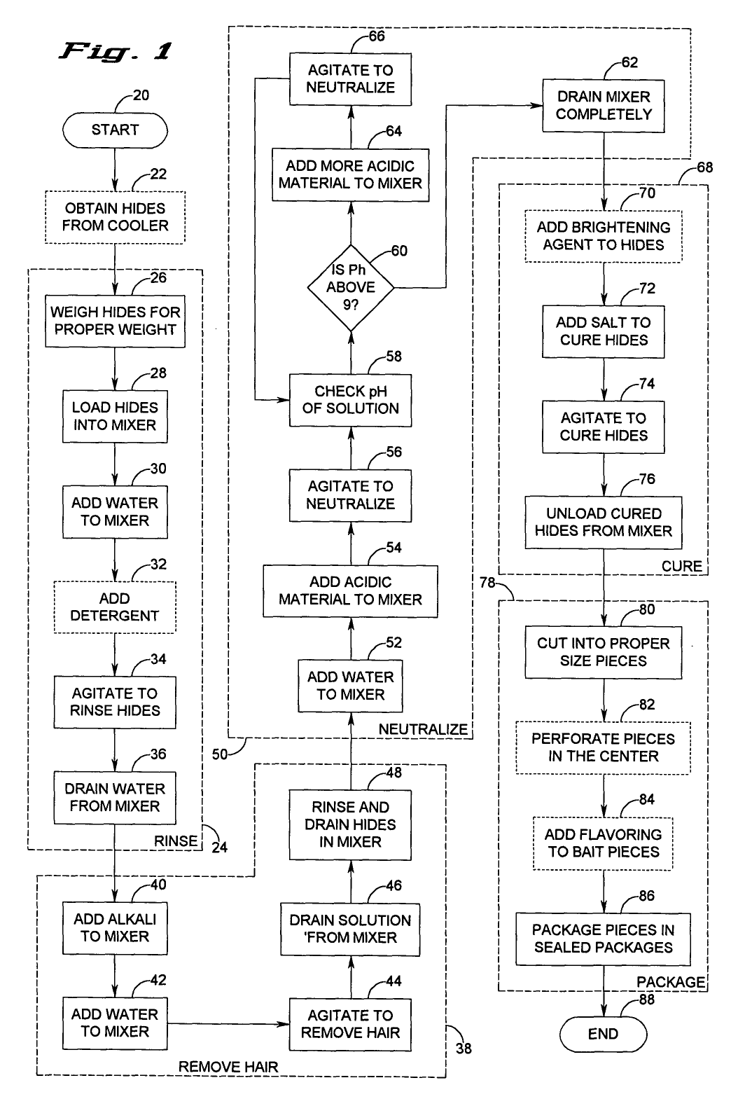

The preferred embodiment of the improved crustacean bait of the present invention is manufactured according to a manufacturing process which will be described herein. As previously mentioned, the crustacean bait manufacturing process of the present invention includes three principal processes which are essential to the manufacturing process, with one additional process preceding the three essential processes and a second additional process following the three essential processes. There are also several steps which are performed as part of several of the processes which are optional, but will be described herein in conjunction with FIG. 1, which depicts a flowchart illustrated in the crustacean bait preferred manufacturing process of the present invention.

The crustacean bait manufacturing process of the present invention begins with a process initiation step 20, following which a plurality of hides which will be used in the process of the present invention to make the improved crustacean bait are obtained. The hides are preferably beef hides, cowhides, and veal skins which are available in relatively large quantities and which have little value if they are not suitable for use in making leather. The hides are typically in chunks which typically weigh between three and eight pounds and typically range in size from eight by eleven inches to three times that size. Optionally, hides of skins from other animals may be used instead, including sow skins, pork skins, buffalo hides, or the hides or skins from any other mammal which is available in sufficient quantities. Optionally, the hides may be accumulated and stored in a cooler to prevent them from decomposing, with the hides being taken from the cooler prior to the performance of the first process of the crustacean bait manufacturing method of the present invention in an optional obtain hides from cooler step 22.

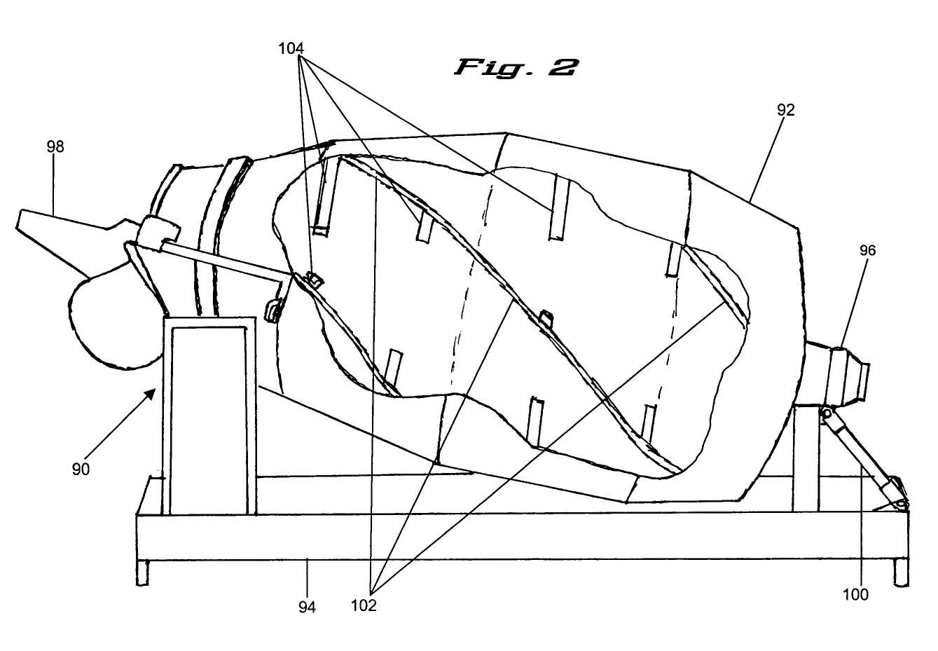

The crustacean bait manufacturing process of the present invention then moves to a rinsing process 24 which is performed in the preferred embodiment, but is not one of the three essential manufacturing processes of the crustacean bait manufacturing method of the present invention. The rinsing process 24, as well as the hair removal process 38, the neutralizing process 50, and the curing process 68 are all performed in a mixing device suitable to agitate the hides and any materials, solid or liquid, which are added to the hides. In the preferred embodiment a large mixing device such as a modified hydro-mechanical concrete mixer (which will be shown and discussed below in conjunction with FIG. 2) with a fifteen thousand pound capacity is used to process four thousand pounds of hides at a time.

The first step in the rinsing process 24 is to weight the hides to properly load the mixing device in a weigh hides for proper weight step 26. As mentioned above, four thousand pounds of hides are processed as a single load in the mixing device used as an example herein. It will be noted and appreciated by those skilled in the art that all weights of materials and volumes of liquids used in the crustacean bait manufacturing process of the present invention are specified for a four thousand pound load of hides, and would have to be adjusted accordingly for other weights of hides processed as a single load.

The hides are then loaded into the mixing device in a load hides into mixer step 28. Water is then added to the hides in the mixing device to rinse the hides in an add water to mixer step 30. In the example used herein, approximately seven hundred gallons of warm water are used for the rinsing process 24. In the preferred embodiment, the temperature of the water used to rinse the hides is approximately ninety degrees (all temperatures mentioned herein are provided in the Fahrenheit scale), although it could vary from approximately fifty degrees to one hundred ten degrees. Optionally, detergent may also be added to the mixing device in an add detergent step 32 if the hides are extremely soiled and dirty. In the example used herein, approximately twenty ounces of detergent are added for each two thousand pounds of hides, for a total of forty ounces of detergent added for the four thousand pounds of hides.

The mixing device is then used to agitate the load in an agitate to rinse hides step 34 for approximately thirty to forty-five minutes in the preferred embodiment, although it may be agitated for between approximately fifteen minutes and one hour. Next, the water is completely drained from the mixing device in a drain water from mixer step 36. This completes the rinsing process 24, which removes most of the foreign materials, manure, and dirt from the hides.

Following the rinsing process 24, the crustacean bait manufacturing process of the present invention then moves to a hair removal process 38 which is the first of the three essential manufacturing processes of the crustacean bait manufacturing method of the present invention. A material used to remove the hair from the hides is added to the hides in the mixing device. In the preferred embodiment, the material used to remove hair from the hides is an alkali material. For example, Sample Trial L001295A from Hydrite Chemical Company in Brookfield, Wis. may be used as the alkali material to remove hair from the hides. This alkali material contains (by weight) twenty-five percent sodium hydroxide, twenty percent calcium hydroxide, and fifteen percent magnesium hydroxide.

The alkali material is added to the mixing device in an add alkali to mixer step 40. In the preferred embodiment, the amount of the alkali material which is added is fourteen percent by weight of the weight of the hides, although the amount added can vary from five to twenty percent by weight to the weight of the hides. In the example used herein, five hundred sixty pounds of Sample Trial L001295A alkali material is added to the mixing device. Next, water is added to the mixing device in an add water to mixer step 42 to create an alkali solution. In the example used herein, approximately three hundred gallons of water are used for the hair removal process 38. In the preferred embodiment, the temperature of the water used in the hair removal process 38 is approximately one hundred twenty degrees, although it could vary from approximately ninety degrees to one hundred fifty degrees.

The mixing device is then used to agitate the load at approximately twelve RPM in an agitate to remove hair step 44 for approximately one and one-half to two hours in the preferred embodiment, although it may be agitated for between approximately one hour and six hours. The alkali material “softens” the hides by breaking down the proteins in the hides, which enables the hair follicles to be easily removed during agitation. Equally important, the alkali material also facilitates the breakdown of proteins and the release of amino acids when crustacean bait made from the hides is placed into the water, thereby accelerating and enhancing the effectiveness of the crustacean bait. After the agitate to remove hair step 44, the alkali solution is completely drained from the mixing device in a drain solution from mixer step 46.

Next, the hides are rinsed in the mixing device to remove hair which is contained in the mixing device in a rinse and drain hides in a rinse and drain hides in mixer step 48 for approximately twenty to thirty minutes in the preferred embodiment, although they could be rinsed for between approximately ten minutes and one hour. During the rinse and drain hides in the rinse and drain hides in mixer step 48 the hides are agitated in the mixing device, rinse water is added at a rate of approximately fifty gallons per minute, and the rinse water is allowed to continuously drain from the mixing device, taking free hair with it. In the preferred embodiment, the temperature of the water used in the rinse and drain hides in the rinse and drain hides in mixer step 48 is approximately one hundred ten degrees, although it could vary from approximately sixty degrees to one hundred twenty degrees. At the end of the rinse and drain hides in mixer step 48 all of the water is drained from the mixing device. This completes the hair removal process 38, which removes the hair both from the hides and from the mixing device.

Following the hair removal process 38, the crustacean bait manufacturing process of the present invention then moves to a neutralizing process 50 which is the second of the three essential manufacturing processes of the crustacean bait manufacturing method of the present invention. A material used to neutralize the hides in the mixing device. In the preferred embodiment, the material used to neutralize the hides is an acidic material. For example, citric acid may be used as the acidic material to neutralize the hides.

In order to avoid adding undiluted acidic material to the hides, water is added to the mixing device in an add water to mixer step 52. In the example used herein, approximately six hundred to seven hundred gallons of water are used for the neutralizing process 50. In the preferred embodiment, the temperature of the water used in the neutralizing process 50 is approximately fifty degrees, although it could vary from approximately forty degrees to sixty-five degrees. Next, the acidic material is added to the mixing device in an add acidic material to mixer step 54. In the preferred embodiment, the amount of the acidic material which is added is one pound of acidic material for each fifty pounds of hides, although the amount added can vary from one-half pound to two pounds for each fifty pounds of the hides. In the example used herein, eighty pounds of citric acid is added to the mixing device.

The mixing device is then used to agitate the load at approximately twelve RPM in an agitate to neutralize step 56 for approximately twenty minutes in the preferred embodiment, although it may be agitated for between approximately ten minutes and one hour. The acidic solution neutralizes the alkaline nature of the hides in the mixing device. Next, the pH of the solution in the mixing device is checked in a check pH of solution step 58. If the pH of the solution in the mixing device is nine or less as determined in a pH determination step the neutralizing process 60, the process will move to a drain mixer completely step 62. It will be appreciated by those skilled in the art that a different number than nine may be used, with the minimum pH ranging from a pH of four to a pH of eleven.

If, on the other hand, the pH of the solution in the mixing device is greater than nine as determined in the pH determination step the neutralizing process 60, the process will move instead to an add more acidic material to mixer step 64 where an additional ten pounds of the acidic material is added to the mixing device in the preferred embodiment, although from five to fifteen pounds of the acidic material could be added. The mixing device is again used to agitate the load at approximately twelve RPM in an agitate to neutralize step 66 for approximately fifteen minutes in the preferred embodiment, although it may be agitated for between approximately five and thirty minutes.

The process then returns to the check pH of solution step 58, where the pH will again be checked. If the pH is now nine or below, the process will move to the drain mixer completely step 62. If, on the other hand, the pH is still above nine, the process will again move to the add more acidic material to mixer step 64 and the agitate to neutralize step 66, following which it will again return to the check pH of solution step 58 and 60. When the pH is at an acceptable level, the mixing device will be completely drained in the drain mixer completely step 62. This completes the neutralizing process 50, which neutralizes the hides.

Following the neutralizing process 50, the crustacean bait manufacturing process of the present invention then moves to a curing process 68 which is the third of the three essential manufacturing processes of the crustacean bait manufacturing method of the present invention. Optionally, a brightening agent may be added to the mixing device in an add brightening agent to hides step 70 to whiten or brighten the hides if desired. Brightening the hides will make the improved crustacean bait of the present invention more visible in traps or pots on the ocean floor. In the preferred embodiment, the brightening agent is hydrogen peroxide, and thirty to sixty seconds of contact with a one to one and one-half percent hydrogen peroxide solution is sufficient for brightening. In the example used herein, a sufficient amount of the brightening agent is added to the mixing device to bring the brightening agent to the proper concentration.

Next, salt is added to the mixing device in an add salt to mixer step 72. In the preferred embodiment, the amount of salt which is added is twenty percent by weight of the weight of the hides, although the amount added can vary from ten to thirty percent by weight to the weight of the hides. In the example used herein, eight hundred pounds of salt is added to the mixing device. No water is added to the mixing device, since the residual water contained in the mixing device and in the hides is sufficient for the curing process.

The mixing device is then used to agitate the load at approximately ten RPM in an agitate to cure hides step 74 for approximately fifteen hours in the preferred embodiment, although it may be agitated for between approximately eight hours and twenty-four hours. The salt displaces the water contained in the hides to cure them, and, together with residual water contained in the mixing device at the beginning of the curing process 68, results in a brine solution being contained in the mixing device together with the cured hides. After the agitate to cure hides step 74, the cured hides together with the brine solution are removed from the mixing device in an unload cured hides from mixer step 76. This completes the curing process 68, which cures the hides.

Following the curing process 68, the crustacean bait manufacturing process of the present invention finally moves to a packaging process 78 which is performed in the preferred embodiment, but is not one of the three essential manufacturing processes of the crustacean bait manufacturing method of the present invention. The first step in the packaging process 78 is to cut the hides into pieces of the desired size for use as crustacean bait in a cut into proper size pieces step 80. The desired size for pieces of crustacean bait are approximately four inches square, and typically weigh between four and eight ounces, although they can vary in size as desired (but typically are not lighter than three ounces or heavier than a pound). The hides may be cut into pieces of crustacean bait either by hand or by using an automated machine.

Optionally, the pieces of crustacean bait may be perforated with a small hole in the center in a perforate pieces step 82 to facilitate mounting the pieces of crustacean bait on a pin, hook, or other retaining means in a crustacean trap or pot. In the preferred embodiment, the hole in the pieces of crustacean bait is approximately one-quarter to one-half inch in diameter, although it may be smaller or larger as desired.

In the preferred embodiment, the pieces of crustacean bait are packed in bulk in plastic bags or plastic containers (typically, between five pounds and fifty pounds of crustacean bait per bag or container) to allow them to be sealed therein. The bags or containers may be pre-printed with the name and address of the manufacturer, instructions for handling and use of the crustacean bait, and a use-before date. Optionally, in an add flavoring to bait pieces step 84, a flavoring additive may be added to the pieces of crustacean bait in each bag or container prior to sealing the bag or container. In the preferred embodiment, the flavoring additives are fish oils from any one of a variety of fish to produce a crustacean bait flavored with fish oil from a particular fish which is in the ocean waters where the crustacean bait is to be used. Examples of different fish flavors include (but are not limited to) mackerel, tuna, anchovy, herring, and menhaden.

After the proper amount of pieces of crustacean bait has been placed into a bag, and flavoring has been added if desired, the bags are heat sealed in a package pieces in sealed packages step 86. If a plastic container is used instead of a plastic bag, it will be fitted with a sealing cover. The bags or containers of crustacean bait are then typically stacked on pallets (for example, forty pound bags may be stacked five per layer, ten layers high). They are then shipped to distributors and end users of the improved crustacean bait of the present invention. Following the packaging process 78, the crustacean bait manufacturing process of the present invention concludes in a process completion step 88.

Turning next to FIG. 2, a mixing device 90 which may be used in the process illustrated in FIG. 1 is shown in a somewhat schematic fashion. The mixing device 90 is a modified hydro-mechanical concrete mixer with a fifteen thousand pound capacity. The mixing device 90 has a mixer drum 92 which has an inclined axis with the open end of the mixer drum 92 (at the left in FIG. 2) being higher than the closed end of the mixer drum 92 (at the right in FIG. 2). The mixer drum 92 is mounted on a base member 94, and is rotated at variable speeds by a motorized transmission unit 96 located at the closed end of the mixer drum 92. Located at the open end of the mixer drum 92 is a loading/unloading trough 98 which may be used to add material to the mixer drum 92. Located at the closed end of the mixer drum 92 is a hydraulic lift unit 100 which may be used to elevate the closed end of the mixer drum 92, thereby facilitating the draining of the contents of the mixer drum 92 through the loading/unloading trough 98.

Located inside the mixer drum 92 are several helical flighting segments 102 (also referred to as mixing spirals or helical blades) which extend inwardly and are used to mix the contents of the mixer drum 92. The helical flighting segments 102 are standard inside the mixer drum 92 of the mixing device 90. If the mixing device 90 is made without the hydraulic lift unit 100, in which case the contents of the mixer drum 92 are removed by reversing the rotation of the mixing drum 92 (upon reverse rotation, the helical flighting segments 102 move the contents of the mixer drum 92 toward the open end thereof). In order to obtain an enhanced degree of agitation inside the mixer drum 92 to process hides, a number of three inch “C” channel segments 104 are welded to the flighting. In the preferred embodiment, the “C” channel segments 104 extend radially inwardly from the helical flighting segments 102 for a length of approximately eighteen inches, and are located along the helical flighting segments 102 at approximately eighteen inch intervals.

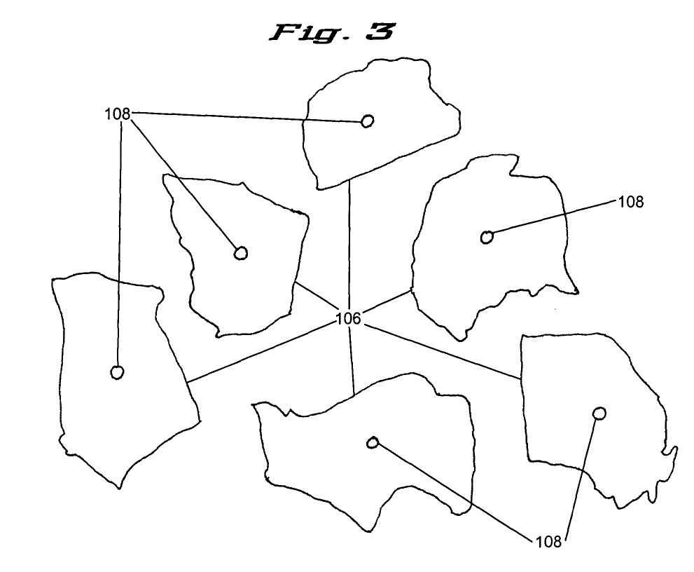

Referring now to FIG. 3, a plurality of pieces of crustacean bait 106 which have been made according to the teachings of the present invention are illustrated. It may be seen that they are of irregular configurations, but they are all of roughly the same size (a size suitable for use as a single piece of crustacean bait) and/or roughly the same weight. Located proximate the center of each of the pieces of crustacean bait 106 is an aperture 108 which extends through the pieces of crustacean bait 106. The apertures 108 are used to mount the pieces of crustacean bait 106 on a pin, hook, or other retaining means in a crustacean trap or pot as mentioned above.

It may thus be seen that the crustacean bait of the present invention is convenient to use, and since it has been cured it does not need to be refrigerated. It has a shelf life of approximately one year, and is generally substantially more inexpensive than bait fish. When placed in traps or pots in the ocean as bait, the improved crustacean bait of the present invention lasts for ten to fourteen days in warmer water and for three to four weeks in colder water. In addition, the improved crustacean bait of the present invention does not degrade in its quality as bait, continuing to release amino acids (proteins) which attract lobsters and crabs throughout its extended useful life.

It may therefore be appreciated from the above detailed description of the preferred embodiment of the present invention that it teaches an improved crustacean bait which is very long-lasting when placed into a trap or pot in the ocean. The improved crustacean bait of the present invention will neither decompose over an extended period of time nor degrade in its attractiveness to lure crustaceans into a trap or pot into which the improved crustacean bait has been placed. The improved crustacean bait of the present invention also has a very long shelf life, both before and after the packaging in which the improved crustacean bait is supplied is opened.

The improved crustacean bait of the present invention is precut to pieces of the proper size for use in crustacean traps and pots, thereby obviating both the need to cut it to pieces of the proper size and the concurrent potential for injuries incurred while cutting bait. The improved crustacean bait of the present invention has little or no odor, and it is not particularly attractive to flies. In addition, the improved crustacean bait of the present invention is environmentally friendly and thus presents no health or safety drawbacks in its use as a bait for crustaceans.

The improved crustacean bait of the present invention is cured and may be stored at room temperature rather than being frozen, thereby obviating the need to store it in a refrigerator or in a freezer. In addition to all of its other advantages, the improved crustacean bait of the present invention is convenient to obtain, to store, and to use. The improved crustacean bait of the present invention is also relatively inexpensive to purchase to enhance its market appeal and to thereby afford it the broadest possible market. Finally, all of the aforesaid advantages and objectives of the improved crustacean bait of the present invention are achieved without incurring any substantial relative disadvantage.

Although the foregoing description of the present invention has been shown and described with reference to particular embodiments and applications thereof, it has been presented for purposes of illustration and description and is not intended to be exhaustive or to limit the invention to the particular embodiments and applications disclosed. It will be apparent to those having ordinary skill in the art that a number of changes, modifications, variations, or alterations to the invention as described herein may be made, none of which depart from the spirit or scope of the present invention. The particular embodiments and applications were chosen and described to provide the best illustration of the principles of the invention and its practical application to thereby enable one of ordinary skill in the art to utilize the invention in various embodiments and with various modifications as are suited to the particular use contemplated. All such changes, modifications, variations, and alterations should therefore be seen as being within the scope of the present invention as determined by the appended claims when interpreted in accordance with the breadth to which they are fairly, legally, and equitably entitled.

1. A method for making crustacean bait, comprising:
removing the hair from one or more hides or skins from a mammal by treating said hides or skins with an alkali solution;
neutralizing the pH of said hides or skins after said hides or skins are treated with said alkali solution to remove said hair therefrom; and
curing said hides or skins with a salt solution after said hides or skins have had said hair removed therefrom and are neutralized.

2. A method as defined in claim 1, wherein said removing step comprises:
placing said hides or skins in a mixing device;
adding an alkali material to said mixing device;
adding water to said mixing device; and
agitating said hides or skins, said alkali material, and said water in said mixing device, said alkali material and said water forming an alkali solution.

3. A method as defined in claim 2, wherein said water temperature is approximately one hundred twenty degrees, and wherein said hides or skins and said alkali solution are agitated in said mixing device for approximately one and one-half to two hours.

4. A method as defined in claim 2, wherein the amount of said alkali material is approximately fourteen percent by weight of the weight of said hides or skins.

5. A method as defined in claim 2, wherein said removing step additionally comprises:
draining said alkali solution from said mixing device;
continuously adding rinse water to said mixing device and agitating said hides or skins and said water to rinse said hides and skins; and
continuously draining said rinse water from said mixing device.

6. A method as defined in claim 5, wherein said rinse water temperature is approximately one hundred ten degrees and said hides or skins and said rinse water are agitated in said mixing device for approximately twenty to thirty minutes.

7. A method as defined in claim 2, wherein said alkali material includes at least one of the materials from the group consisting of sodium hydroxide, calcium hydroxide, and magnesium hydroxide.

8. A method as defined in claim 1, wherein said neutralizing step comprises:
adding an acidic material to a mixing device containing said hides or skins;
adding water to said mixing device; and
agitating said hides or skins, said acidic material, and said water in said mixing device, said acidic material and said water forming an acidic solution.

9. A method as defined in claim 8, wherein said water temperature is approximately fifty degrees, and wherein said hides or skins and said acidic solution are agitated in said mixing device for approximately twenty minutes.

10. A method as defined in claim 8, wherein the amount of said acidic material is approximately one pound of acidic material for each fifty pounds of said hides or skins.

11. A method as defined in claim 8, wherein said neutralizing step additionally comprises:
checking the pH of said acidic solution to determine whether or not the pH of said acidic solution is at or below a particular level;
draining said acidic solution from said mixing device if said pH of said acidic solution is at or below said particular value; and
adding an additional quantity of said acidic material to said mixing device if said pH of said acidic solution is not at or below said particular value, and then repeating said agitating and checking steps.

12. A method as defined in claim 11 wherein said particular value of pH is approximately nine.

13. A method as defined in claim 8, wherein said acidic material is citric acid.

14. A method as defined in claim 1, wherein said curing step comprises:
adding salt to a mixing device containing said hides or skins; and
agitating said hides or skins and said salt in said mixing device, said salt curing said hides or skins.

15. A method as defined in claim 14, wherein the amount of said salt is approximately twenty percent by weight of the weight of the hides.

16. A method as defined in claim 14, wherein said hides or skins and said salt are agitated in said mixing device for approximately fifteen hours.

17. A method as defined in claim 14, wherein said curing step additionally comprises:
adding a brightening agent to said mixing device containing said hides or skins.

18. A method as defined in claim 17, wherein said brightening agent comprises:
hydrogen peroxide.

19. A method as defined in claim 1, additionally comprising:
rinsing said hides or skins prior to treating said hides or skins with said alkali solution.

20. A method as defined in claim 19, wherein said rinsing step comprises:
adding rinse water to a mixing device containing said hides or skins; and
agitating said hides or skins and said rinse water in said mixing device to remove most foreign materials, manure, and/or dirt from said hides or skins.

21. A method as defined in claim 20, wherein said rinse water temperature is approximately ninety degrees, and wherein said hides or skins and rinse water are agitated in said mixing device for approximately thirty to forty-five minutes.

22. A method as defined in claim 20, wherein said rinsing step additionally comprises:
adding a detergent to said mixing device prior to said agitating step.

23. A method as defined in claim 1, additionally comprising:
packaging said hides or skins after curing said hides or skins with said salt solution.

24. A method as defined in claim 23, wherein said packaging step comprises:
cutting said hides or skins into pieces of a desired size; and
placing a plurality of said pieces of said hides or skins into a plastic container and sealing said plastic container.

25. A method as defined in claim 24, wherein said pieces of said hides or skins are approximately four inches square.

26. A method as defined in claim 24, wherein said packaging step additionally comprises:
perforating each of said pieces of said hides or skins with a small hole near the center thereof.

27. A method as defined in claim 24, wherein said packaging step additionally comprises:
placing a flavoring additive into said plastic container prior to sealing said plastic container.

28. A method as defined in claim 27, wherein said flavoring additive comprises:
fish oil.

29. A method as defined in claim 28, wherein said fish oil is derived from a fish from the group consisting of mackerel, tuna, anchovy, herring, and menhaden.

30. A method as defined in claim 1, wherein said mixing device has a plurality of axially inwardly-extending bars to enhance the degree of agitation afforded by rotating said mixing device.

31. A method as defined in claim 1, wherein said hides or skins comprise:
at least one from the group consisting of beef hides, cowhides, veal skins, sow skins, pork skins, or buffalo hides.

32. A crustacean bait made by the method defined in claim 1.

33. A method for making crustacean bait, comprising:
rinsing one or more hides or skins from a mammal to remove foreign materials, manure, and/or dirt from said hides or skins;
removing the hair from one or more hides or skins from a mammal by treating said hides or skins with an alkali solution;
neutralizing the pH of said hides or skins after said hides or skins are treated with said alkali solution to remove said hair therefrom;
curing said hides or skins with a salt solution after said hides or skins have had said hair removed therefrom and is neutralized; and
packaging said hides or skins for distribution to distributors and/or end users.

34. A crustacean bait made by the method defined in claim 33.

35. A method for making crustacean bait, comprising:
removing the hair from one or more hides or skins from a mammal;
neutralizing the pH of said hides or skins after said hides or skins are treated to remove said hair therefrom; and
curing said hides or skins to stabilize them after said hides or skins have had said hair removed therefrom and are neutralized.

36. A crustacean bait made by the method defined in claim 35.

37. A crustacean bait made of hides or skins from a mammal having hair, said hides or skins having had said hair removed by treating said hides or skins with an alkali solution, said hides or skins then having been neutralized to lower the pH to an acceptable level, said hides or skins thereafter having been cured with a salt solution to stabilize them.
